(19) United States
(12) Patent Application Publication
(10) Pub. No.: US 2023/0342629 A1
(43) Pub. Date: Oct. 26, 2023

(54) EXPLORING ENTITIES OF INTEREST OVER MULTIPLE DATA SOURCES USING KNOWLEDGE GRAPHS

(71) Applicant: Microsoft Technology Licensing, LLC, Redmond, WA (US)

(72) Inventors: Sarah PANDA, Bothell, WA (US); Harsh SHRIVASTAVA, Redmond, WA (US)

(21) Appl. No.: 17/729,957

(22) Filed: Apr. 26, 2022

(51) Int. Cl. G06N 5/02

(52) U.S. Cl. CPC G06N 5/02

(57) ABSTRACT

The present disclosure relates to methods and systems for exploring textual data. The methods and systems identify entities and the relations among the entities within the text of an initial data source and generate knowledge graphs on-the-fly for the identified entities and the relations. The methods and systems apply one or more functions on the nodes of an initial knowledge graph and extend the initial knowledge graph in response to the one or more functions applied. The methods and systems use a different data source to generate a second knowledge graph for the extended initial knowledge graph. The methods and systems generate a merged knowledge graph with the initial knowledge graph and the second knowledge graph.

### BACKGROUND

Extracting knowledge from textual data, such as, research papers, patent documents, etc., is a well-studied problem and is of wide interest. Knowledge graphs are often used to represent the knowledge extracted from the documents in a condensed form. Knowledge graphs typically provide a framework to understand massive data in a compressed manner. In general, the search and exploration space for knowledge graphs is restricted to either the source dataset or the pre-built knowledge base. Moreover, knowledge graphs can become so large that it becomes difficult to navigate the vast amount of information included in the knowledge graphs. The information included in knowledge graphs may become noise and not of interest to the user. In addition, the information in existing knowledge graphs may not be valid as the information used to create the knowledge graphs may have changed and the knowledge graphs may need to be updated to keep the information relevant.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes generating an initial knowledge graph with a plurality of nodes and a plurality of edges using an initial data source. The method includes selecting at least one function to apply to a node of the plurality of nodes, wherein an output of the at least one function includes a new node and a new edge. The method includes generating an extended initial knowledge graph based on the output of the at least one function, wherein the extended initial knowledge graph includes the initial knowledge graph with the new node connected to the node using the new edge. The method includes generating a second knowledge graph using another data source, wherein the second knowledge graph includes the new node, a plurality of second nodes, the new edge, and a plurality of second edges. The method includes creating a merged knowledge graph with the initial knowledge graph and the second knowledge graph, wherein the node of the initial knowledge graph is connected to the new node of the second knowledge graph using the new edge.

Some implementations relate to a system. The system includes one or more processors; memory in electronic communication with the one or more processors; and instructions stored in the memory, the instructions executable by the one or more processors to: generate an initial knowledge graph with a plurality of nodes and a plurality of edges using an initial data source; select at least one function to apply to a node of the plurality of nodes, wherein an output of the at least one function includes a new node and a new edge; generate an extended initial knowledge graph based on the output of the at least one function, wherein the extended initial knowledge graph includes the initial knowledge graph with the new node connected to the node using the new edge; generate a second knowledge graph using another data source, wherein the second knowledge graph includes the new node, a plurality of second nodes, the new edge, and a plurality of second edges; and create a merged knowledge graph with the initial knowledge graph and the second knowledge graph, wherein the node of the initial knowledge graph is connected to the new node of the second knowledge graph using the new edge.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for generating knowledge graphs in accordance with implementations of the present disclosure.

FIG. 2A illustrates an example of an initial knowledge graph generated in accordance with implementations of the present disclosure.

FIG. 2B illustrates an example function to apply to an initial knowledge graph in accordance with implementations of the present disclosure.

FIG. 2C illustrates an example of an extended initial knowledge graph in accordance with implementations of the present disclosure.

FIG. 2D illustrates an example of second knowledge graph generated in accordance with implementations of the present disclosure.

FIG. 2E illustrates an example of a third knowledge graph generated in accordance with implementations of the present disclosure.

FIG. 2F illustrates an example merged knowledge graph generated in accordance with implementations of the present disclosure.

FIG. 3 illustrates an example method for generating knowledge graphs in accordance with implementations of the present disclosure.

### DETAILED DESCRIPTION

This disclosure generally relates to creating intelligence out of documents. Knowledge graphs are often used to represent the knowledge extracted from the documents in a condensed form. Knowledge graphs represent knowledge as concepts and the relationships between the concepts. Knowledge graphs typically provide a framework to understand massive data in a compressed manner. In general, the search and exploration space for knowledge graphs is restricted to either the source dataset or the pre-built knowledge base. Moreover, knowledge graphs can become so large that it becomes difficult to navigate the vast amount of information included in the knowledge graphs. The information included in knowledge graphs may become noise and not of interest to the user. In addition, the information in existing knowledge graphs may not be valid as the information used to create the knowledge graphs may have changed and the knowledge graphs may need to be updated to keep the information relevant.

Knowledge graphs extract information out of the documents by analyzing the text of the document and extracting content of the documents. In general, knowledge graphs want to extract valuable knowledge from the documents. One example of a knowledge graph is extracting words and phrases from the documents as entities in the graph (e.g., nodes of the graph) with different relationships of the words and phrases (e.g., edges of the graph). The edges connect the different nodes of the knowledge graph with a connection (e.g., a link or line) illustrating the relationships between the nodes. For example, the documents are medical documents and the different drugs mentioned in the medical document are included in the knowledge graph as the entities (nodes of the graph) and the edges of the graphs are the different relationships identified in the medical documents between the drugs (e.g., different side effects of the drugs or how the drugs interact with each other). Another example includes a medical document, and the knowledge graph includes different proteins and drugs discussed in the medical document as the nodes of the knowledge graph and the edges of the knowledge graph represent how the proteins and drugs interact. Another example includes the text of the medical document includes a sentence “The patient has diabetes, and we treated the patient with insulin and there was glucose deficiency.” The knowledge graph includes diabetes, insulin, and glucose as nodes (the identified entities in the text of the document) and the edges of the knowledge graph are the relations (e.g., medicine) among the identified entities. Another example includes documents about a city's transportation system and the knowledge graph includes nodes with the different stops on the transportation system and the edges show the different forms of transportation (train, bus, car) between the stops. Another example includes knowledge graphs for patents. The nodes in the knowledge graphs are patents and authors and the edges may represent connections among the patent and/or authors. The type of connection may be optionally specified, for example, as the topic or subfield of the invention. As such, the knowledge graphs represents the information extracted from the text of the documents in a condensed form.

The present disclosure provides methods and systems for exploring textual data from different data sources. The methods and systems identify relevant entities and the relations among the relevant entities within the text. The relevant entities may be based on a given area of interest. One example of relevant entities includes for a given area of interest of Protein or Drug, the relevant entities in the document collection include a list of proteins and drugs present in the document. The methods and systems generate knowledge graphs on-the-fly that act as a smart compendium of the extracted knowledge from the text. The knowledge graphs are generated in real time without requiring pre-computation. The knowledge graphs may be further utilized for downstream tasks, such as, answering graph-based queries, exploring nontrivial connections between entities, summarization of the textual data, etc.

The methods and systems may hop from one textual data source to another via query-based traversal of intermediate knowledge graphs that are generated on-the-fly. The methods and systems facilitate exploration over multiple textual data sources. In general, the search and exploration space is restricted to either the source dataset or the pre-built knowledge base. The methods and systems of the present disclosure enables search across different data sources. The methods and systems integrate different exploration functions desired and merge different data sources using intermediate on-the-fly creation of knowledge graphs.

The methods and systems may explore on the fly by adding newer datasets to the knowledge graphs, and thus, helps with keeping information relevant in the knowledge graphs without banking on stale information. Portions of pre-built knowledge graphs may become irrelevant with time as the data used to create the knowledge graphs changes or is outdated. As such, the methods and systems solve the problem of keeping the knowledge relevant to the datasets at hand. The methods and systems may be implemented as a plug and play framework so as needed multiple entity and relation extraction models or even subgraphs from pre-built graphs can be integrated.

An example use case includes applying the methods and systems to explore protein specific information in textual data from a set of papers on research about proteins. The user in the example is interested in knowing more about protein ‘pA.’ The methods and systems first use generic health entity and relation extraction models to produce a knowledge graph from the set of papers on the research about proteins. A subset of the nodes of this graph include protein names. In this example, if traditional knowledge mining is used, the search for the protein ‘pA’ is restricted to this graph. However, the methods and systems provide additional options to the user to do further exploration. For instance, if the user is interested in finding other proteins that are structurally similar to ‘pA,’ the methods and systems apply a function to identify structurally similar proteins that are structurally similar to the protein ‘pA’ and receive the output as protein ‘pB’ (a protein structurally similar to the protein ‘pA’). The methods and systems extend the original knowledge graph by adding an edge with an appropriate edge description between the two protein nodes ‘pA’ and ‘pB.’ Furthermore, the new protein ‘pB’ may be present in other sets of research papers that are different from the original set of papers, thereby facilitating hopping and traversing between different sets of data sources. The methods and systems also run the same health entity and relation extraction module on the new set of papers which generates its corresponding knowledge graph. The new knowledge graph is then merged with the original graph, providing several more connections to aid the user in knowledge exploration.

The methods and systems apply one or more functions on the nodes of the knowledge graph and extend the knowledge graph in response to the function(s) applied. In addition, the methods and systems may suggest one or more functions to apply based on a selected node. The functions output one or more nodes to add to the knowledge graph. The methods and systems search for the new nodes through a different data source and expand the knowledge graphs further using the different data source. As such, the methods and systems start from one data source and keep expanding the knowledge graphs using different sources of data based on the functions applied to the nodes, other documents sources, and/or other knowledge graphs. The methods and systems grow the knowledge graph using the different data sources.

One technical benefit of the methods and systems of the present disclosure is leveraging different data sources to generate a knowledge graph. The methods and systems make connections between different data sources to extend a knowledge graph using different data sources while keeping the information in the extended knowledge graphs relevant to a user. Another technical benefit of the methods and systems of the present disclosure is discovering information and the connections from different data sources faster. The methods and systems provide information from different data source in a condensed manner allowing users to discover the information faster from the different data sources.

Another technical benefit of the methods and systems of the present disclosure is generating the knowledge graphs on-the-fly with the current information in the data sources. Thus, the knowledge graph generated is based on current information available in the data sources when the user is requesting the knowledge graph, instead of requesting an existing knowledge graph with possibly stale information.

Another technical benefit of the methods and systems of the present disclosure is aiding the user in creating unique knowledge graphs. The methods and systems may allow the user to select one or more functions to apply to a knowledge graph and the user may gradually expand the knowledge graph in a unique way (e.g., based on a specific area of interest, or a selected topic) by adding different data sources and applying different functions to grow the knowledge graphs. As such, the users may design unique knowledge graphs. Moreover, the knowledge graphs may change each time based on a current interest of the user.

As such, the method and systems provide efficient ways to explore entities of interest by first creating an on-the-fly knowledge graph based on an original data source. The methods and systems generate intermediate knowledge graphs based on the choice of exploration selected by the user (e.g., the selected functions or other data sources selected). The methods and systems explore other existing data corpuses using the generated intermediate knowledge graphs. Thus, the methods and systems may navigate between multiple data sources, and thereby, find connections between the multiple data sources.

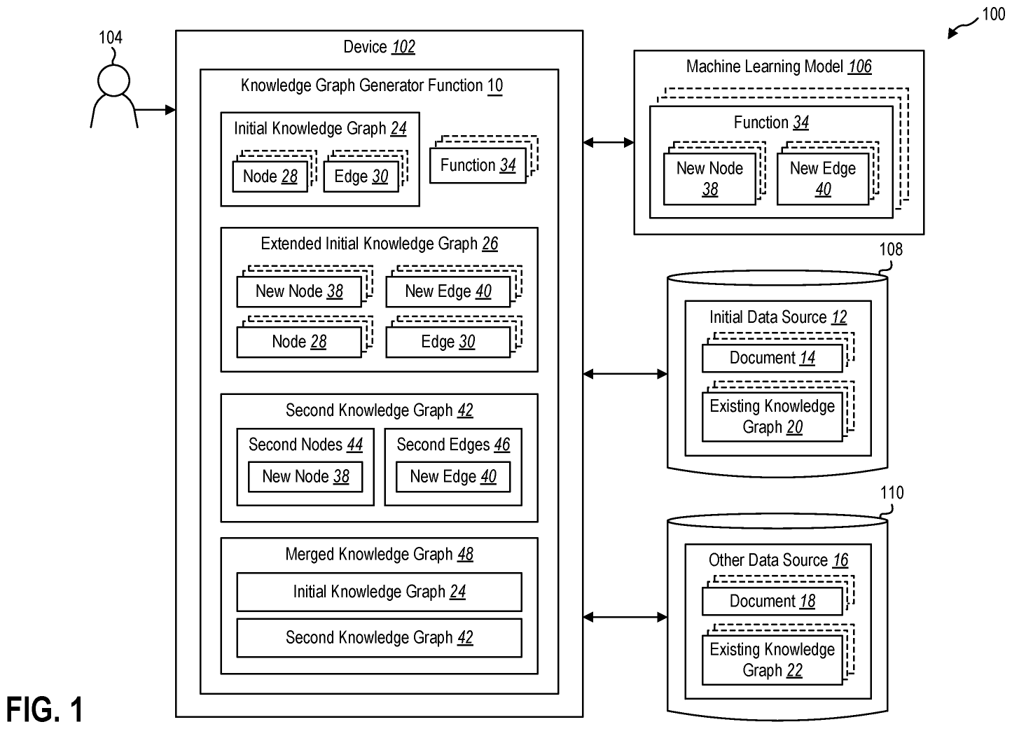

Referring now to FIG. 1, illustrated is an example environment 100 for generating knowledge graphs. The environment 100 includes one or more devices 102 that one or more users 104 may access to generate knowledge graphs. The device 102 includes a knowledge graph generator function 10 that generates one or more knowledge graphs from one or more data sources (e.g., initial data source 12, other data source 16) that include one or more documents (e.g., documents 14, 18). Knowledge graphs consists of concepts from the documents 14, 18 represented as nodes and relations among the nodes as edges. Documents include a portable document format (PDF)s and/or any collection of text data. In some implementations, the data sources include large pre-built knowledge graphs (e.g., existing knowledge graphs 20, 22) already built for a topic.

In some implementations, the datastores are containers. In some implementations, the data sources are in different datastores. For example, the initial data source 12 is in datastore 108 and the other data source 16 is in datastore 110. In some implementations, the data sources are in the same datastore. For example, the initial data source 12 and the other documents source 16 are in the datastore 108. In some implementations, the data sources (e.g., the initial data source 12 and the other data source 16) are from the same content provider. In some implementations, the data sources (e.g., the initial data source 12 and the other data source 16) are from different content providers.

The knowledge graph generator function 10 includes a document parser component that extracts the raw text from the documents 14, 18. The raw text from each of the documents 14, 18 is combined together into a single document of raw text. The knowledge graph generator function 10 also includes an entity and relation extraction model. The documents 14 may be documents that the user 104 accessed or that the user 104 identified as being of interest.

The entity and relation extraction model identifies the entities in the raw text of the documents and relations among the different entities and generates an initial knowledge graph 24. The entities are nodes 28 in the initial knowledge graph 24 and the relationships are the edges 30. Each node 28 has a text (e.g., a name of the node) and a type. For example, one node 28 has a text “SOCS3” and a type of “protein” and a different node 28 has a text “ibuprofen” and a type of “drug.”

In some implementations, the initial knowledge graph 24 is generated in response to a request by the user 104 to generate a knowledge graph. For example, the user 104 may be exploring different documents 14 in the initial data source 12 and may select a formula requesting the generation of a knowledge graph to represent the information in the documents 14.

The knowledge graph generator function 10 generates the initial knowledge graph 24 on-the-fly. On-the-fly is when the knowledge graph generator function 10 extracts entities from the initial data source 12 to create the initial knowledge graph 24 in response to receiving a request to generate the knowledge graph. As such, the initial knowledge graph 24 is generated on-the-fly with the processing performed in real-time without interrupting the run by directly operating on the data source (e.g., initial data source 12) and extracting the knowledge graph information from the data source in one go without interrupting the compute. If new documents are added to the initial data source 12, the next time the knowledge graph generator function 10 runs, the initial knowledge graph 24 is created based on the new documents added to the initial data source 12. As such, the initial knowledge graph 24 is not preset but is generated in response to a request to create the initial knowledge graph 24 based on the information extracted for the initial data source 12.

The knowledge graph generator function 10 may apply one or more functions 34 to the initial knowledge graph 24 and expand the initial knowledge graph 24 with one or more new nodes 38 based on the output of the functions 34. The functions 34 receive a node 28 of interest from the initial knowledge graph 24, performs processing on the node 28, and outputs one or more new nodes 38 and/or new edges 40 based on the processing.

The knowledge graph generator function 10 may access a machine learning model 106 that performs the one or more functions 34. The machine learning model 106 may include a plurality of functions with each function 34 performing different processing. The functions 34 may be pre-trained machine learning models. One example of the machine learning models include deep learning machine learning models that receive an input, process the input, and provide an output based on the processing. In some implementations, the functions 34 are heuristic graph based algorithms. As such, the functions 34 may be of deterministic (algorithm based) or predictive (machine learning or deep learning based) nature. Optionally, the functions 34 may also take into account the previously observed data and/or trends for a certain task to enhance the performance of the functions 34. For example, the task may be to predict structurally similar proteins and the function 34 may take a protein entity as input and run a machine learning model to output a list of structurally similar proteins.

The functions 34 may provide an answer to a question or query. One example function 34 is to identify similar objects or items. The function 34 receives the text of the node 28 and the type of the node 28 (e.g., the object name and/or object type) as an input and outputs one or more similar objects based on the processing. Another example function 34 is to identify side-effects of a drug. The function 34 receives the text of the node 28 and the type of the node 28 as the input with the drug name and outputs one or more side-effects of the drug based on the processing performed by the machine learning model 106.

The functions 34 are used to expand the initial knowledge graph 24 by identifying a new node 38 that has a new edge 40 (e.g., a relationship) to one or more nodes 28 in the initial knowledge graph 24. The functions 34 also provide connections between different data sources (e.g., the initial data source 12 and the other data source 16) and expand the initial knowledge graph 24 with information from different data sources.

In some implementations, the knowledge graph generator function 10 provides suggestions with different functions 34 to select based on the type and/or the text of the nodes 28. The user 104 may select one or more functions 34 or a combination of functions 34 from the set of suggested functions. For example, if the user 104 is interested in a protein in the initial knowledge graph 24 identified by the text and/or the type of the node 28, the knowledge graph generator function 10 may provide a set of functions 34 relating to proteins as suggestions to the user 104.

In some implementations, the user 104 provides a function 34 or a combination of functions 34 to use (e.g., the user designs a specific function or a combination of functions to use). One example of a user defined function includes finding similar proteins. One example of a combination of functions includes taking an output of one function and applying another function (chaining) to get the desired result. For example, the user 104 is interested to see a list of structurally similar proteins to protein ‘pA’ and wants to find the drugs associated with those proteins. The user 104 may use a combination of functions to achieve the results (e.g., a first function to output similar proteins to ‘pA’ and applying a second function to the output of the first function to find related drugs to the similar proteins). In some implementations, the knowledge graph generator function 10 automatically selects a function 34 or a combination of functions 34 to use.

The knowledge graph generator function 10 may plug in other models to use as the functions 34. In some implementations, the functions 34 are specific to a certain domain of users. Examples of functions specific to a certain domain of users include named entity recognition (NER) and relation extraction for specific types.

The output of the function 34 or the combination of function 34 includes one or more new nodes 38 and one or more new edges 40 based on the processing of the functions 34. The knowledge graph generator function 10 expands the initial knowledge graph 24 with the new node(s) 38 and the new edge(s) 40 and generates an extended initial knowledge graph 26 with the nodes 28, the edges 30, the new node(s) 38, and the new edge(s) 40. The new edge(s) 40 connects each new node 38 to at least one node 28 of the initial knowledge graph 24. In addition, the new edge(s) 40 identify a relationship or a connection between the at least one node 28 of the initial knowledge graph 24 and the new node(s) 38 of the extended initial knowledge graph 26.

In some implementations, the extended initial knowledge graph 26 is editable by the user 104. The knowledge graph generator function 10 receives input from the user 104 with one or more modifications to the extended initial knowledge graph 26. The user 104 may make any desired modification to the extended initial knowledge graph 26. One example of a modification to the extended initial knowledge graph 26 is the user 104 changes a relationship between the new node 38 and the node 28 and adds a different label to the new edge 40 or moves the new node 38 to connect to a different node in the initial knowledge graph 24. Another example of a modification to the extended initial knowledge graph 26 is the user 104 removes a new node 38 and new edge 40 from the extended initial knowledge graph 26. Another example of a modification to the extended initial knowledge graph 26 is the user 104 adds a new node 38 and a new edge 40 to the extended initial knowledge graph 26. Another example of a modification to the extended initial knowledge graph 26 is the user 104 changes the text or type of the new node 38. Another example of a modification to the extended initial knowledge graph 26 is the user 104 removes a node 28 and edge 30 from the extended initial knowledge graph 26. As such, the user 104 may make any number of modifications and/or changes to the extended initial knowledge graph 26. The knowledge graph generator function 10 may update the extended initial knowledge graph 26 in response to the input received by the user 104.

In some implementations, the knowledge graph generator function 10 may apply additional functions 34 to the extended initial knowledge graph 26. The user 104 may select additional functions 34 to apply to the extended initial knowledge graph 26 by adding new node(s) 38 and new edge(s) 40 to the extended initial knowledge graph 26.

In some implementations, the knowledge graph generator function 10 may access another data source 16 with a plurality of documents 18 and/or existing knowledge graphs 22 and perform a search for the new node(s) 38 in the other data source 16 to generate a second knowledge graph 42 based on the new node(s) 38 and the new edge(s) 40 of the extended initial knowledge graph 26. The other data source 16 includes information different from the information included in the initial data source 12 (e.g., different documents 18 and/or existing knowledge graphs 22). Since the new node(s) 38 were not identified as part of the initial knowledge graph 24, the new node(s) 38 are not entities included in the documents 14 and/or existing knowledge graphs 20 of the initial data source 12.

In some implementations, the knowledge graph generator function 10 generates the second knowledge graph 42 by using existing knowledge graphs 22. As such, the second knowledge graph 42 is automatically created using existing knowledge graphs 22 that are already created for the entity or topic identified in the text and/or the type of the new node(s) 38.

In some implementations, the knowledge graph generator function 10 generates the second knowledge graph 42 on-the-fly based on entity extraction and relation identification from the documents 18 in the other data source 16. As such, the second knowledge graph 42 is generated based on the information contained in the text and/or the type of the new node(s) 38 and extracted from the documents 18. The second knowledge graph 42 includes the new node(s) 38, the new edge(s) 40, the second nodes 44 (e.g., the entities extracted from the documents 18), and the second edges 46 (e.g., the relationships identified in the documents between the entities).

The second knowledge graph 42 may also be editable by the user 104. The knowledge graph generator function 10 receives input from the user 104 with one or more modifications to the second knowledge graph 42. The user 104 may make any desired modification to the second knowledge graph 42. The knowledge graph generator function 10 may update the second knowledge graph 42 in response to the input received by the user 104.

The knowledge graph generator function 10 may output a merged knowledge graph 48 with the initial knowledge graph 24 and the second knowledge graph 42. The initial knowledge graph 24 is connected to the second knowledge graph 42 by at least one new edge 40. The merged knowledge graph 48 identifies connections between the different data sources (e.g., the new edge(s) 40 identifying a relationship between the node(s) 26 in the initial knowledge graph 24 and the new node(s) 38 in the second knowledge graph 42). In addition, the merged knowledge graph 48 aids the user 104 in discovering more knowledge by exploring the merged knowledge graph 48 based on the different data sources (e.g., the initial data source 12 and the other data source 16) in a compressed form. The merged knowledge graph 48 makes it easy to share knowledge between different data sources (e.g., the initial data source 12 and the other data source 16) quickly in an easy to understand manner.

The merged knowledge graph 48 may also be editable by the user 104. The knowledge graph generator function 10 receives input from the user 104 with one or more modifications to the merged knowledge graph 48. The user 104 may make any desired modification to the merged knowledge graph 48. The knowledge graph generator function 10 may update the merged knowledge graph 48 in response to the input received by the user 104.

In some implementations, the knowledge graph generator function 10 may further expand the merged knowledge graph 48 by applying one or more functions 34 to the merged knowledge graph 48 and generating an extended merged knowledge graph with new nodes and/or new edges based on the one or more functions 34. The knowledge graph generator function 10 may access yet another data source different from the initial data source 12 and the other data source 16 and generate a third knowledge graph from the extended merged knowledge graph on-the-fly based on analysis of the text of documents in another data source or using an existing knowledge graph in another data source.

As such, the knowledge graph generator function 10 may continue to expand the knowledge graphs by applying one or more functions 34 to the different knowledge graphs generated (e.g., the initial knowledge graph 24, the extended initial knowledge graph 26, the second knowledge graph 42, the extended second knowledge graph 42, the merged knowledge graph 48, the extended merged knowledge graph, etc.). In addition, the knowledge graph generator function 10 may continue to access different data sources to further expand the different knowledge graphs generated.

The knowledge graphs (e.g., the initial knowledge graph 24, the extended initial knowledge graph 26, the second knowledge graph 42, the extended second knowledge graph 42, the merged knowledge graph 48, the extended merged knowledge graph, etc.) may be further utilized for downstream tasks by the user 104, such as, answering graph-based queries, exploring connections between entities, summarization of the textual data, etc.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the knowledge graph generator function 10, the machine learning model 106, the initial data source 12, and/or the other data source 16 is implemented wholly on the same computing device. Another example includes one or more subcomponents of the knowledge graph generator function 10, the machine learning model 106, the initial data source 12, and/or the other data source 16 are implemented across multiple computing devices. Moreover, in some implementations, one or more subcomponent of the knowledge graph generator function 10, the machine learning model 106, the initial data source 12, and/or the other data source 16 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

The environment 100 may generate an initial knowledge graph 24 on-the-fly based on an initial data source 12. The environment 100 may expand the initial knowledge graph 24 by applying one or more functions 34 to the initial knowledge graph 24 and using other data sources 16 based on the one or more functions 34 applied to generate a second knowledge graph 42. As such, the environment 100 may leverage different data sources (e.g., the initial data source 12 and the other data source 16) to expand the initial knowledge graph 24 and to grow the initial knowledge graph 24 using different data sources.

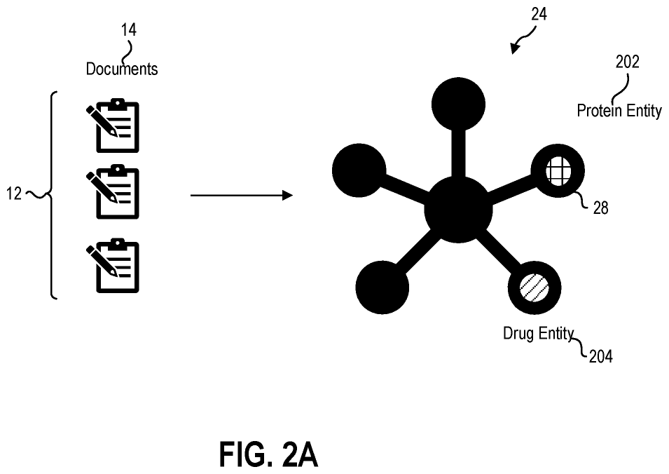

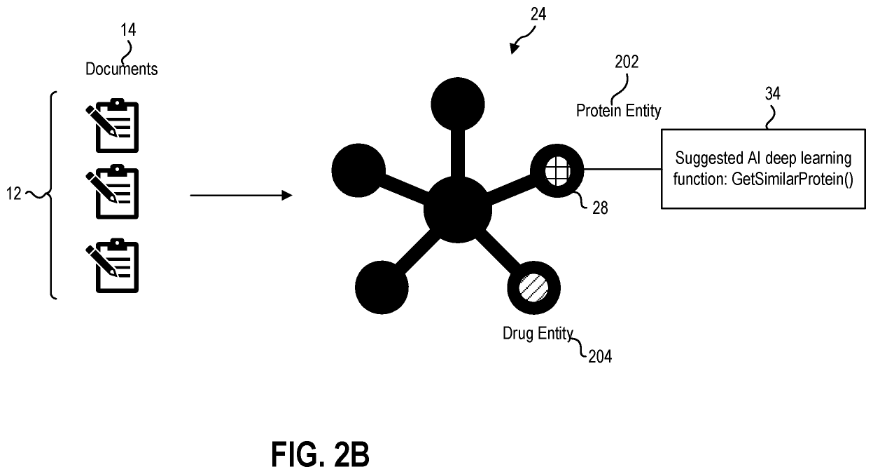

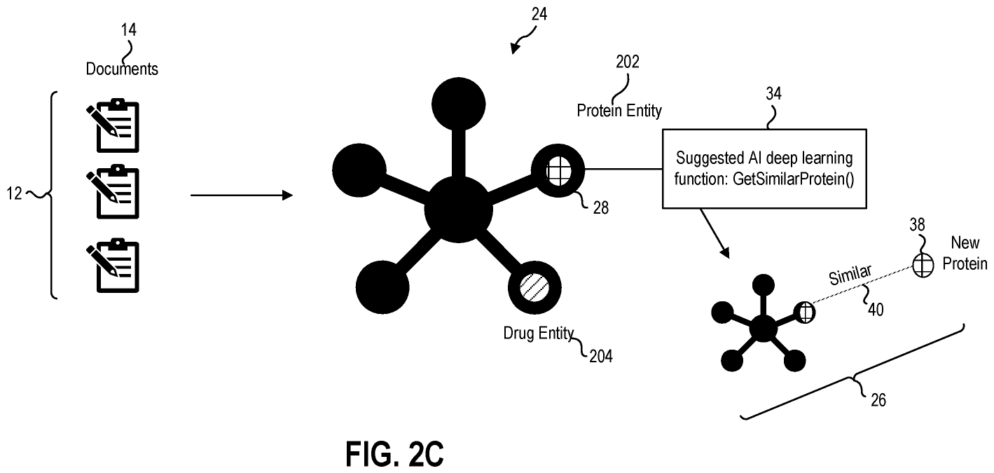

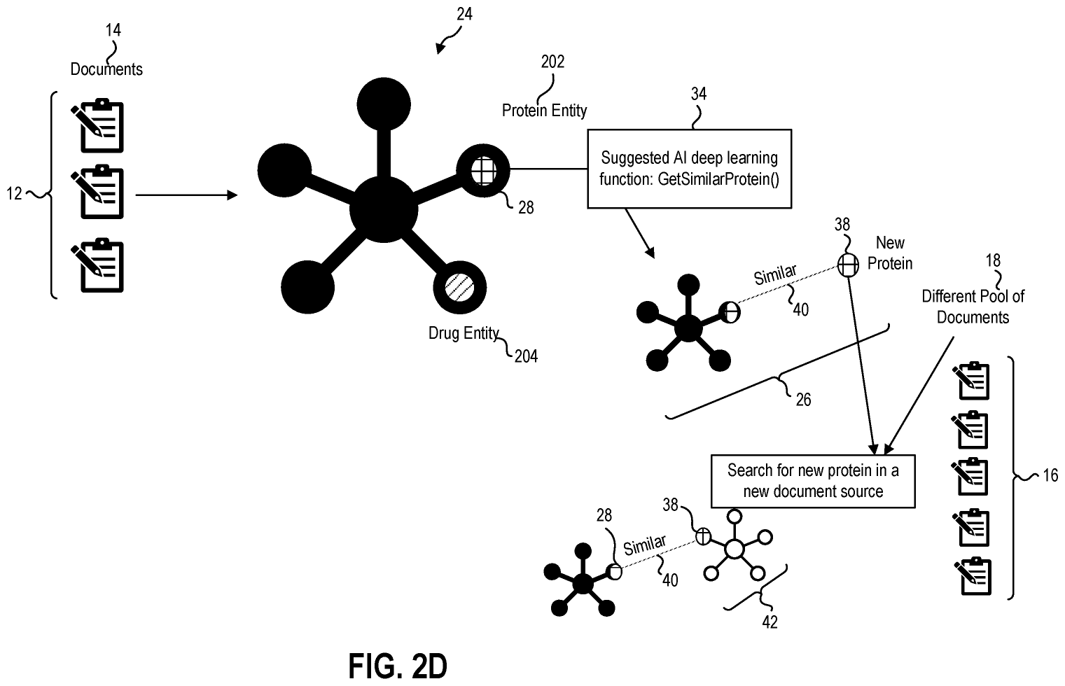

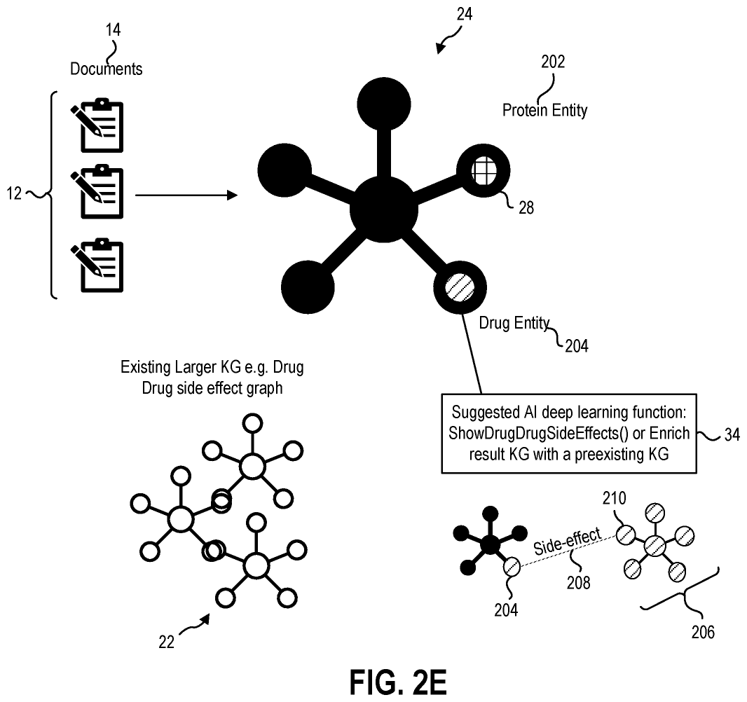

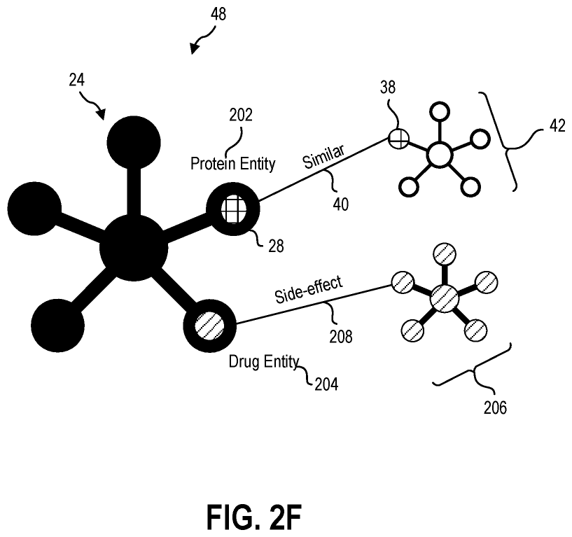

Referring to FIG. 2A, illustrated is an example of an initial knowledge graph 24 generated on-the-fly from an initial data source 12. The initial data source 12 includes one or more documents 14 (e.g., PDFs, articles, journals, and/or any source of text). The initial knowledge graph 24 is generated using any existing methods for entity identification from the initial data source 12. The knowledge graph generator function 10 (FIG. 1) generates the initial knowledge graph 24 in real time or near real time in response to receiving a request to generate the initial knowledge graph 24 and extracts entities from the text of the documents 14 and creates the initial knowledge graph 24. For example, the user 104 (FIG. 1) may provide a request for the initial knowledge graph creation. As such, the initial knowledge graph 24 is not preset but is generated by the knowledge graph generator function 10 based on the information extracted from the documents 14 of the initial data source 12 in response to receiving the request for the initial knowledge graph creation.

The initial knowledge graph 24 in this example includes health entities as the nodes (e.g., nodes 28) and relations between the health entities as the edges (e.g., edges 30). For example, the node 28 includes a protein entity 202, and a different node includes a drug entity 204. Different node types may be visually distinct from each other (e.g., the protein entities 202 are one color, and the drug entities 204 are a different color) making it easy for the user 104 to easily identify the different nodes in the initial knowledge graph 24.

Referring now to FIG. 2B, illustrated is an example function 34 to apply to a selected node 28 of the initial knowledge graph 24. In some implementations, a set of functions are presented to the user 104 as suggestions and the user 104 may select the function 34 to apply to the initial knowledge graph 24. In some implementations, the function 34 is automatically selected by the knowledge graph generator function 10.

In the illustrated example, the function 34 identifies similar proteins for the protein entity 202 of the node 28. The user 104 may be interested in learning more about the protein entity 202 of the node 28 and selects the function 34 to identify other similar proteins. The function 34 requires an input (e.g., the protein entity) and provides an output (e.g., one or more similar proteins). The function 34 is a deep learning model that receives an input, performs processing on the input, and provides an output based on the processing.

Referring now to FIG. 2C, illustrated is an example of an extended initial knowledge graph 26 of the initial knowledge graph 24 with a new node 38. The knowledge graph generator function 10 generates the extended initial knowledge graph 26 based on the output of the function 34. The new node 38 included in the extended initial knowledge graph 26 is the output of the function 34 (e.g., the similar protein identified during the processing to the protein). The new edge 40 to the new node 38 is the relation (e.g., similar protein) identified by the function 34. As such, the initial knowledge graph 24 is extended based on the output of the function 34 with a similar protein in the new node 38 that was not included in the documents 14 of the initial data source 12.

Referring now to FIG. 2D, illustrated is an example of a second knowledge graph 42 generated from the extended initial knowledge graph 26 based on searching of the other data source 16 for the new protein identified in the new node 38. The other data source 16 includes a different pool of documents 18 and/or knowledge graphs 22 to search for the new protein than the documents 14 included in the initial data source 12. The new protein was not included in the initial knowledge graph 24, and thus, the new protein node 38 was not present in the initial data source 12 (e.g., the new protein was not in any of the documents included in the initial data source 12).

The knowledge graph generator function 10 generates the second knowledge graph 42 based on the entities and the relationships among the entities identified during the searching of the other data source 16. The second knowledge graph 42 is generated using any existing methods for entity identification from the other data source 16. The second knowledge graph 42 is connected to the initial knowledge graph 24 through the new edge 40 between the similar proteins (e.g., node 28 and new node 38). The second knowledge graph 42 extends the initial knowledge graph 24 by using information from the other data source 16. As such, connections may be easier to identify between the initial data source 12 and the other data source 16.

Referring now to FIG. 2E, illustrated is an example of a third knowledge graph 206 generated for the initial knowledge graph 24. For example, the user 104 is interested in a drug entity 204 and selects a function 34 to show the side effects of the drug entity 204. The initial knowledge graph 24 is expanded with the output from the function 34 with the side-effect as the new node 210 with the new edge 208 connecting the new node 210 to the drug entity 204 of the initial knowledge graph 24. The knowledge graph generator function 10 generates the third knowledge graph 206 using an existing knowledge graph 22 for the side-effect. As such, instead of generating the third knowledge graph 206 using entity extraction from the documents 18 (as illustrated in FIG. 2D, the third knowledge graph 206 is generated using the existing knowledge graph 22 for the side-effect.

Referring now to FIG. 2F, illustrated is a merged knowledge graph 48 with the initial knowledge graph 24, the second knowledge graph 42, and the third knowledge graph 206. The user can easily discover more knowledge by exploring the expanded graphs (e.g., the second knowledge graph 42 and the third knowledge graph 206) based on the other data source 16 in a compressed form. The second knowledge graph 42 and/or the third knowledge graph 206 makes it easy to share knowledge between different data sources quickly in an easy to understand manner.

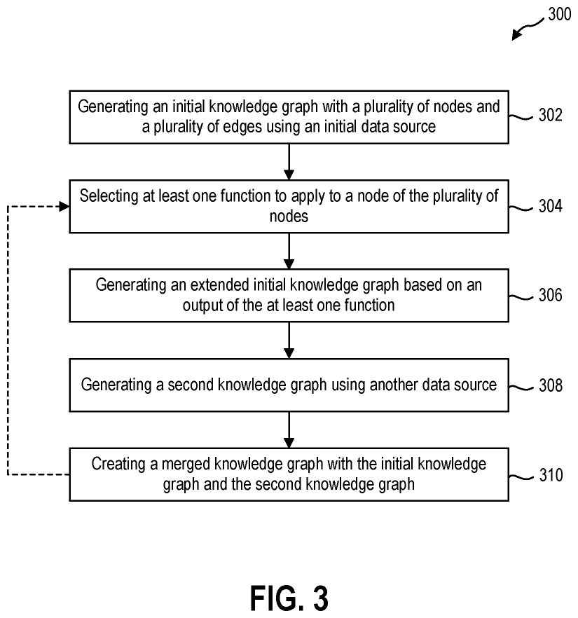

Referring now to FIG. 3, illustrated is an example method 300 for generating knowledge graphs. The actions of method 300 are discussed below with reference to the architecture of FIG. 1.

At 302, the method 300 includes generating an initial knowledge graph with a plurality of nodes and a plurality of edges using an initial data source. The initial data source 12 includes a plurality of documents 14. The documents 14 include a PDF, an article, a journal, or any source of text. The knowledge graph generator function 10 generates the initial knowledge graph 24 by identifying and/or extracting a plurality of entities and a plurality of relationships among the plurality of entities from text of the documents 14 of the initial data source 12. Each node 28 corresponds to an entity and each edge 30 corresponds to a relationship among the entities. The initial knowledge graph 24 may be generated using any existing methods for entity identification from the initial data source 12.

In some implementations, the initial knowledge graph 24 is generated in response to a request to generate a knowledge graph. The knowledge graph generator function 10 extracts entities from the initial data source 12 to create the initial knowledge graph 24 in response to receiving a request to generate the knowledge graph. As such, the initial knowledge graph 24 is generated on-the-fly based on the information extracted from the initial data source 12 in response to a request the generate the initial knowledge graph 24.

At 304, the method 300 includes selecting at least one function to apply to a node of the plurality of nodes. The knowledge graph generator function 10 may apply one or more functions 34 to the initial knowledge graph 24 and expand the initial knowledge graph 24 with one or more new nodes 38 based on the output of the function 34. The output of the function 34 includes a new node 38 and a new edge 40.

The functions 34 receive a node 28 of interest from the initial knowledge graph 24, performs processing on the node 28, and outputs one or more new nodes 38 and/or new edges 40 based on the processing. In some implementations, the functions 34 are pre-trained machine learning models. One example of the machine learning models include deep learning machine learning models that receive an input, process the input, and provide an output based on the processing. In some implementations, the functions 34 are heuristic graph based algorithms. The functions 34 may provide an answer to a question or query. One example function 34 is to identify similar objects or items. The function 34 receives the text of the node 28 and the type of the node 28 (e.g., the object name and/or object type) as an input and outputs one or more similar objects based on the processing. Another example function 34 is to identify side-effects of a drug. The function 34 receives the text of the node 28 and the type of the node 28 as the input with the drug name and outputs one or more side-effects of the drug based on the processing performed by the machine learning model 106.

In some implementations, the knowledge graph generator function 10 provides a plurality of functions as a suggestion to the user 104. The plurality of functions are selected based on a type of the node 28 or a text of the node 28. The knowledge graph generator function 10 receives a selection of the function 34 from the plurality of functions provided. For example, the user 104 may select one or more functions 34 or a combination of functions 34 from the set of suggested functions.

In some implementations, the knowledge graph generator function 10 automatically selects the function 34 or a combination of functions 34 based on a type of the node 28 or a text of the node 28. In some implementations, the user 104 provides a function 34 or a combination of functions 34 to use (e.g., the user designs a specific function or a combination of functions to use).

At 306, the method 300 includes generating an extended initial knowledge graph based on the output of the at least one function. The knowledge graph generator function 10 expands the initial knowledge graph 24 with the new node(s) 38 and the new edge(s) 40 and generates an extended initial knowledge graph 26 with the nodes 28, the edges 30, the new node(s) 38, and the new edge(s) 40. The new edge(s) 40 connects each new node 38 to at least one node 28 of the initial knowledge graph 24.

In some implementations, the knowledge graph generator function 10 may apply additional functions 34 to the extended initial knowledge graph 26. The user 104 may select additional functions 34 to apply to the extended initial knowledge graph 26 by adding new node(s) 38 and new edge(s) 40 to the extended initial knowledge graph 26.

In some implementations, the extended initial knowledge graph 26 is editable by the user 104. The knowledge graph generator function 10 receives input from the user 104 with one or more modifications to the extended initial knowledge graph 26. The user 104 may make any desired modification to the extended initial knowledge graph 26. The knowledge graph generator function 10 may update the extended initial knowledge graph 26 in response to the input received by the user 104.

At 308, the method 300 includes generating a second knowledge graph using another data source. The knowledge graph generator function 10 generates a second knowledge graph 42 using the other data source 16. The other data source 16 includes documents 18 that are different from the documents 14 in the initial data source 12. The second knowledge graph 42 includes the new node 38, a plurality of second nodes 44, the new edge 40, and a plurality of second edges 46.

In some implementations, the knowledge graph generator function 10 generates the second knowledge graph 42 by identifying and extracting a plurality of second entities and a plurality of second relationships among the second entities in text of the documents 18 of the other data source 16. Each second node 44 corresponds to a second entity and each second edge 46 corresponds to a second relationship. The second knowledge graph 42 is generated using any existing methods for entity identification from the initial data source 12. As such, the second knowledge graph 42 is generated on-the-fly based on the information extracted from the documents 18.

In some implementations, the knowledge graph generator function 10 generates the second knowledge graph 42 by using an existing knowledge graph 22. As such, the second knowledge graph 42 is automatically created using existing knowledge graphs 22 that are already created for the entity or topic identified in the text and/or the type of the new node(s) 38.

The second knowledge graph 42 may also be editable by the user 104. The knowledge graph generator function 10 receives input from the user 104 with one or more modifications to the second knowledge graph 42. The user 104 may make any desired modification to the second knowledge graph 42. The knowledge graph generator function 10 may update the second knowledge graph 42 in response to the input received by the user 104.

At 310, the method 300 includes creating a merged knowledge graph with the initial knowledge graph and the second knowledge graph. The knowledge graph generator function 10 may create a merged knowledge graph 48 with the initial knowledge graph 24 and the second knowledge graph 42 where the node 28 of the initial knowledge graph 24 is connected to the new node 38 of the second knowledge graph 42 using the new edge 40.

The merged knowledge graph 48 identifies connections between the different data sources (e.g., the new edge(s) 40 identifying a relationship between the node(s) 26 in the initial knowledge graph 24 and the new node(s) 38 in the second knowledge graph 42). The merged knowledge graph 48 aids the user 104 in discovering more knowledge by exploring the merged knowledge graph 48 based on the different data sources (e.g., the initial data source 12 and the other data source 16) in a compressed form. The merged knowledge graph 48 makes it easy to share knowledge between different data sources (e.g., the initial data source 12 and the other data source 16) quickly in an easy to understand manner.

The merged knowledge graph 48 may also be editable by the user 104. The knowledge graph generator function 10 receives input from the user 104 with one or more modifications to the merged knowledge graph 48. The user 104 may make any desired modification to the merged knowledge graph 48. The knowledge graph generator function 10 may update the merged knowledge graph 48 in response to the input received by the user 104.

The method 300 may repeat and the knowledge graph generator function 10 may select another function 34 to apply to a selected node of the merged knowledge graph 48. The other function 34 outputs another new node and another new edge to extend the merged knowledge graph 48 further. The method 300 may generate an extended merged knowledge graph with the merged knowledge graph 48, the other new node, and the other new edge. The other new node is connected to the selected node using the other new edge. The method may continue to repeat and expanding the knowledge graphs.

As such, the method 300 may gradually grow the knowledge graphs by applying one or more functions to the different knowledge graphs generated, searching across different data sources to generate extended knowledge graphs, and/or extending the knowledge graphs using existing knowledge graphs. In addition, the method 300 may aid the user 104 in creating unique knowledge graphs.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a transformer model, a classification model, a regression model, a language model, an object detection model) that can be tuned (e.g., trained) based on training input to approximate unknown functions. For example, a machine learning model may refer to a neural network (e.g., a transformer neural network, a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, embodiments of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. Unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
generating an initial knowledge graph with a plurality of nodes and a plurality of edges using an initial data source;
selecting at least one function to apply to a node of the plurality of nodes, wherein an output of the at least one function includes a new node and a new edge;
generating an extended initial knowledge graph based on the output of the at least one function, wherein the extended initial knowledge graph includes the initial knowledge graph with the new node connected to the node using the new edge;
generating a second knowledge graph using another data source, wherein the second knowledge graph includes the new node, a plurality of second nodes, the new edge, and a plurality of second edges; and
creating a merged knowledge graph with the initial knowledge graph and the second knowledge graph, wherein the node of the initial knowledge graph is connected to the new node of the second knowledge graph using the new edge.

2. The method of claim 1, wherein the initial data source includes a plurality of documents including one or more of a portable document format (PDF), an article, a journal, or any source of text.

3. The method of claim 2, wherein the initial knowledge graph is generated by:
identifying and extracting a plurality of entities and a plurality of relationships among the plurality of entities from text of the plurality of documents of the initial data source, wherein each node of the plurality of nodes corresponds to an entity of the plurality of entities and each edge of the plurality of edges corresponds to a relationship among the plurality of relationships.

4. The method of claim 1, wherein the other data source includes a plurality of documents that are different from the plurality of documents in the initial data source, wherein the plurality of documents from the other data source include one or more of a portable document format (PDF), an article, a journal, or any source of text.

5. The method of claim 4, wherein the second knowledge graph is generated by:
identifying and extracting a plurality of second entities and a plurality of second relationships among the plurality of second entities in text of the plurality of documents of the other data source, wherein each second node of the plurality of second nodes corresponds to a second entity of the plurality of second entities and each second edge of the plurality of second edges corresponds to a second relationship among the plurality of second relationships.

6. The method of claim 1, wherein the other data source includes one or more existing knowledge graphs, and the second knowledge graph is generated by using an existing knowledge graph of the one or more existing knowledge graphs of the other data source.

7. The method of claim 1, wherein the at least one function is a deep learning machine learning model.

8. The method of claim 1, further comprising:
providing a plurality of functions selected based on a type of the node or a text of the node; and
receiving a selection of the at least one function from the plurality of functions.

9. The method of claim 1, further comprising:
receiving input to edit one or more of the extended initial knowledge graph, the second knowledge graph, or the merged knowledge graph; and
providing modifications to one or more of the extended initial knowledge graph, the second knowledge graph, or the merged knowledge graph based on the input.

10. The method of claim 1, further comprising:
selecting another function to apply to a selected node of the merged knowledge graph, wherein the other function outputs another new node and another new edge; and
generating an extended merged knowledge graph with the merged knowledge graph, the other new node, and the other new edge, wherein the other new node is connected to the selected node using the other new edge.

11. A system, comprising:
one or more processors;
memory in electronic communication with the one or more processors; and
instructions stored in the memory, the instructions executable by the one or more processors to:
generate an initial knowledge graph with a plurality of nodes and a plurality of edges using an initial data source;
select at least one function to apply to a node of the plurality of nodes, wherein an output of the at least one function includes a new node and a new edge;
generate an extended initial knowledge graph based on the output of the at least one function, wherein the extended initial knowledge graph includes the initial knowledge graph with the new node connected to the node using the new edge;
generate a second knowledge graph using another data source, wherein the second knowledge graph includes the new node, a plurality of second nodes, the new edge, and a plurality of second edges; and
create a merged knowledge graph with the initial knowledge graph and the second knowledge graph, wherein the node of the initial knowledge graph is connected to the new node of the second knowledge graph using the new edge.

12. The system of claim 11, wherein the initial data source includes a plurality of documents including one or more of a portable document format (PDF), an article, a journal, or any source of text.

13. The system of claim 12, wherein the instructions are executable by the one or more processors to generate the initial knowledge graph by:
identifying and extracting a plurality of entities and a plurality of relationships among the plurality of entities from text of the plurality of documents of the initial data source, wherein each node of the plurality of nodes corresponds to an entity of the plurality of entities and each edge of the plurality of edges corresponds to a relationship among the plurality of relationships.

14. The system of claim 11, wherein the other data source includes a plurality of documents that are different from the plurality of documents in the initial data source, wherein the plurality of documents from the other data source include one or more of a portable document format (PDF), an article, a journal, or any source of text.

15. The system of claim 14, wherein the instructions are executable by the one or more processors to generate the second knowledge graph by:
identifying and extracting a plurality of second entities and a plurality of second relationships among the plurality of second entities in text of the plurality of documents of the other data source, wherein each second node of the plurality of second nodes corresponds to a second entity of the plurality of second entities and each second edge of the plurality of second edges corresponds to a second relationship among the plurality of second relationships.

16. The system of claim 11, wherein the other data source includes one or more existing knowledge graphs, and the second knowledge graph is generated by using an existing knowledge graph of the one or more existing knowledge graphs of the other data source.

17. The system of claim 11, wherein the at least one function is a deep learning machine learning model.

18. The system of claim 11, wherein the instructions are executable by the one or more processors to:
provide a plurality of functions selected based on a type of the node or a text of the node; and
receive a selection of the at least one function from the plurality of functions.

19. The system of claim 11, wherein the instructions are executable by the one or more processors to:
receive input to edit one or more of the extended initial knowledge graph, the second knowledge graph, or the merged knowledge graph; and
provide modifications to one or more of the extended initial knowledge graph, the second knowledge graph, or the merged knowledge graph based on the input.

20. The system of claim 11, wherein the instructions are executable by the one or more processors to:
select another function to apply to a selected node of the merged knowledge graph, wherein the other function outputs another new node and another new edge; and
generate an extended merged knowledge graph with the merged knowledge graph, the other new node, and the other new edge, wherein the other new node is connected to the selected node using the other new edge.
